(19) United States
(12) Patent Application Publication
(10) Pub. No.: US 2011/0292212 A1
(43) Pub. Date: Dec. 1, 2011

(54) WASHER NOZZLE FOR VEHICLE MOUNTED CAMERA, VEHICLE MOUNTED CAMERA, AND WASHER DEVICE FOR VEHICLE

(75) Inventors: Takeshi Tanabe, Kosai-shi (JP); Hiroshi Matsumoto, Kosai-shi (JP); Masami Muramatsu, Kosai-shi (JP)

(73) Assignee: ASMO CO., LTD., Kosai-shi (JP)

(21) Appl. No.: 13/114,911

(22) Filed: May 24, 2011

(30) Foreign Application Priority Data
May 27, 2010 (JP) 2010-121398
Feb. 21, 2011 (JP) 2011-034818

(51) Int. Cl. H04N 7/18; B05B 1/10

(52) U.S. Cl. 348/148; 239/284.1; 348/E07.085

(57) ABSTRACT

A washer nozzle removes foreign matter on an image capturing surface of a camera mounted to the outside of a vehicle by supplying washer fluid to the image capturing surface. The washer nozzle includes an inside spray hole and a discharge portion. The inside spray hole sprays the washer fluid introduced into the washer nozzle. The discharge portion receives washer fluid sprayed from the inside spray hole. The discharge portion has a passage extending in a direction intersecting the spray direction of the washer fluid and a discharge port connected to the passage. The discharge portion discharges, from the discharge port, washer fluid sprayed from the inside spray hole along the image capturing surface, while filling the passage with the washer fluid, thereby washing the image capturing surface.

### BACKGROUND OF THE INVENTION

The present invention relates to a washer nozzle for a vehicle mounted camera that supplies washer fluid to an image capturing surface thereby removing foreign matter on the image capturing surface, a vehicle mounted camera having the washer nozzle, and a washer device for a vehicle that has the washer nozzle for a vehicle mounted camera.

In recent years, an increased number of vehicles have been equipped with a vehicle mounted camera for capturing images around the vehicle. The outside image captured by a vehicle mounted camera is shown on the monitor of a navigation device mounted in the vehicle. This aids the driver in viewing the surroundings of the vehicle. For example, it is difficult for a driver to see the condition rearward and downward of the vehicle. If a camera is mounted on the rear of a vehicle to capture images of a condition rearward and downward of the vehicle, and images from the camera are shown on the monitor when the vehicle backs up, the driver can sufficiently and easily see the condition rearward and downward of the vehicle.

However, since vehicle mounted cameras are located outside of vehicles, the image capturing surface (lens surface) of a camera often has foreign matter disposed thereon such as rain drops and mud. If such foreign matter is left as is and the camera captures an image from outside, the foreign matter appears in the captured image. In this case, a clear image of the outside cannot be obtained. It is therefore necessary to remove foreign matter caught on the image capturing surface of the camera. Japanese Laid-Open Patent Publication No. 2007-53448 discloses a vehicle mounted camera that removes foreign matter on the image capturing surface of a camera by wiping motion of a wiper or spraying of a liquid or compressed air.

When foreign matter on the image capturing surface of a vehicle mounted camera is removed by the wiping motion of a wiper, the vehicle mounted camera requires a mechanism for causing the wiper to perform the wiping motion. This increases the size of the vehicle mounted camera. Foreign matter can also be removed by spraying liquid. In this case, washer fluid that is originally used for washing the rear window can be supplied to a vehicle mounted camera located at the rear of a vehicle. Therefore, foreign matter can be relatively easily removed.

However, to reliably remove foreign matter from an entire target to be washed in the image capturing surface of a camera (for example, a part that faces an image sensor of the camera via a lens) by spraying liquid such as washer fluid, liquid sprayed from a spray hole of a washer nozzle needs to strike a wide area that includes the target to be washed, as disclosed in Japanese Laid-Open Patent Publication No. 2007-53448. Therefore, the distance between the spray hole and the image capturing surface has to be set far to some extent. That is, a part of liquid spray nozzle that includes a spray hole (aperture) needs to project by a great amount relative to the image capturing surface of the vehicle mounted camera. This increases the size of the spray nozzle. As a result, the presence of the spray nozzle of the vehicle mounted camera is noticeably enhanced from the perspective of the external appearance of the vehicle. This possibly degrades the vehicle appearance.

### SUMMARY OF THE INVENTION

Accordingly, it is an objective of the present invention to provide a compact washer nozzle for a vehicle mounted camera that is capable of reliably washing an image capturing surface of a camera, a vehicle mounted camera having a washer nozzle, and a washer device for a vehicle that has a washer nozzle for a vehicle mounted camera.

To achieve the above objective, a first aspect of the present invention provides a washer nozzle for removing foreign matter on an image capturing surface of a camera mounted to the outside of a vehicle by supplying washer fluid to the image capturing surface. The washer nozzle includes an inside spray hole for spraying washer fluid introduced into the washer nozzle. The washer nozzle further includes a discharge portion for receiving washer fluid sprayed from the inside spray hole. The discharge portion has a passage extending in a direction intersecting the spray direction of the washer fluid and a discharge port connected to the passage. The discharge portion discharges, from the discharge port, washer fluid sprayed from the inside spray hole along the image capturing surface, while filling the passage with the washer fluid, thereby washing the image capturing surface. A vehicle mounted camera integrally having the washer nozzle and a washer device for a vehicle having the washer nozzle are also provided.

A second aspect of the present invention provides a camera mounted to the outside of a vehicle. The camera includes a housing, a camera body, and a washer nozzle. The camera body has an image capturing surface provided on the housing. The washer nozzle supplies washer fluid onto the image capturing surface. The camera further includes a crease located at a part vertically below the image capturing surface. The crease prevents washer fluid that has flowed from vertically above from flowing around to the bottom of the housing.

A third aspect of the present invention provides a vehicle mounted washer device. The vehicle mounted washer device includes a camera body and a washer nozzle. The camera body has a housing and an image capturing surface provided on the housing. The washer nozzle supplies washer fluid onto the image capturing surface. The camera body and the washer nozzle are mounted to the outside of the vehicle. The washer device further includes a crease located at a part vertically below the image capturing surface. The crease prevents washer fluid that has flowed from vertically above from flowing around to the bottom of the housing.

Other aspects and advantages of the invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a schematic diagram showing a washer device for a vehicle according to a first embodiment of the present invention;

FIG. 2A is a perspective view illustrating the vehicle mounted camera with the washer nozzle in the washer device for a vehicle shown in FIG. 1;

FIG. 2B is a cross-sectional view illustrating the vehicle mounted camera with the washer nozzle shown in FIG. 2A;

FIG. 3 is a cross-sectional view illustrating a vehicle mounted camera with a washer nozzle that has a fluidic device according to a second embodiment of the present invention;

FIG. 4 is a perspective view of the fluidic device of FIG. 3;

FIG. 5 is a cross-sectional view of the fluidic device shown in FIG. 3;

FIG. 6A is a perspective view illustrating a vehicle mounted camera with a washer nozzle according to a third embodiment of the present invention;

FIG. 6B is a cross-sectional view illustrating the vehicle mounted camera with a washer nozzle shown in FIG. 6A;

FIG. 7A is a perspective view illustrating a vehicle mounted camera with a washer nozzle according to a fourth embodiment of the present invention;

FIG. 7B is a cross-sectional view illustrating the vehicle mounted camera with a washer nozzle shown in FIG. 7A;

FIG. 8A is a perspective view illustrating a vehicle mounted camera with a washer nozzle according to a modified embodiment;

FIG. 8B is a cross-sectional view illustrating the vehicle mounted camera with a washer nozzle shown in FIG. 8A;

FIG. 9 is a top plan view illustrating attaching of the washer nozzle according to the modified embodiment of FIGS. 8A and 8B;

FIG. 10 is a cross-sectional view illustrating a vehicle mounted camera with a washer nozzle according to a modified embodiment;

FIG. 11 is a cross-sectional view illustrating a vehicle mounted camera with a washer nozzle according to a modified embodiment; and

FIG. 12 is a cross-sectional view illustrating a vehicle mounted camera with a washer nozzle according to a modified embodiment.

### DETAILED DESCRIPTION OF THE PREFERRED EMBODIMENTS

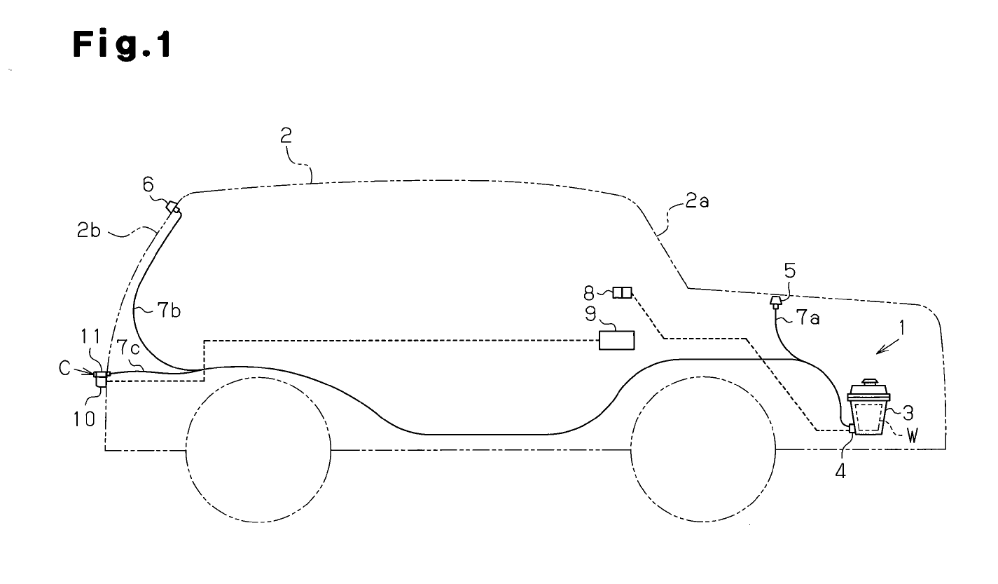

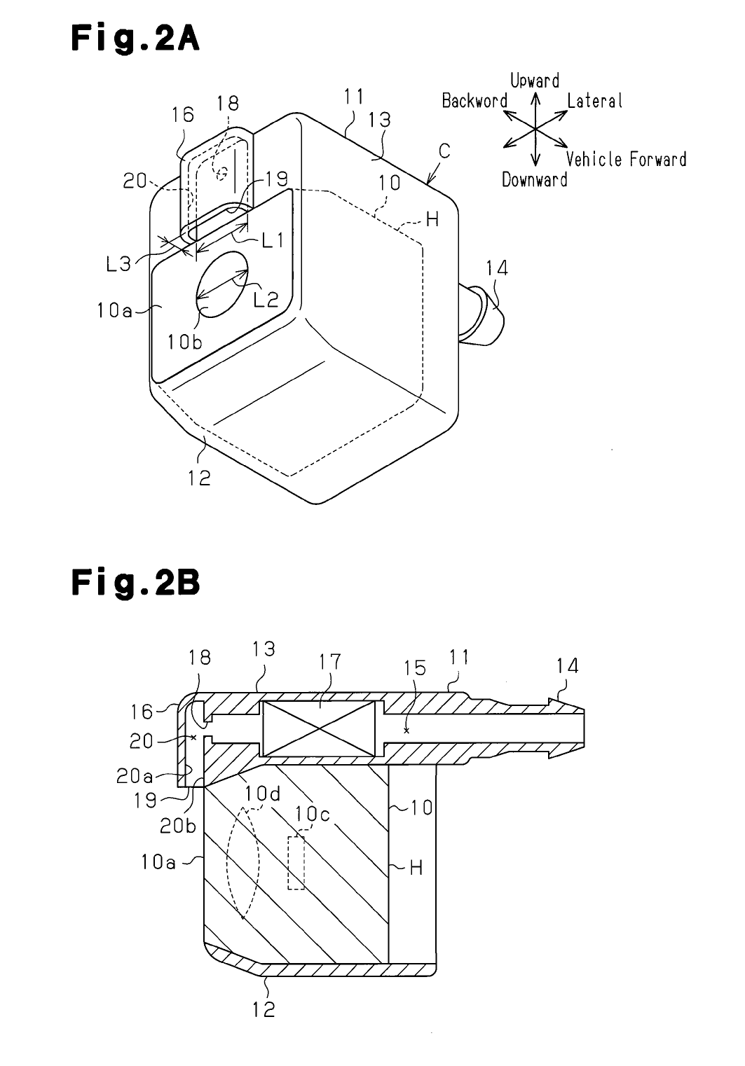

A first embodiment of the present invention will now be described with reference to FIGS. 1 to 2B.

FIG. 1 is a schematic diagram showing a washer device 1 for a vehicle according to a first embodiment of the present invention. As shown in FIG. 1, a washer fluid reservoir 3 is located in the engine compartment of a vehicle 2. Washer fluid W is stored in the washer fluid reservoir 3. A pump device 4 is attached to a side wall of the washer fluid reservoir 3. A tubular inlet (not shown) of the pump device 4 is inserted into the washer fluid reservoir 3. The pump device 4 is connected to a front washer nozzle (front nozzle) 5 and a rear washer nozzle (rear nozzle) 6 via hoses 7a, 7b, respectively. The front nozzle 5 sprays the washer fluid W onto the windshield 2a of the vehicle 2, and the rear nozzle 6 sprays the washer fluid W onto the rear window 2b of the vehicle 2. When the pump device 4 is activated in response to operation of a switch 8 located in the passenger compartment, water fluid W drawn through the inlet of the pump device 4 is sprayed from the front nozzle 5 to the windshield 2a or from the rear nozzle 6 to the rear window 2b.

The vehicle 2 has a car navigation system that includes a monitor 9 located in the passenger compartment and a rear view camera C (hereinafter, simply referred to as a camera C) located at the rear of the vehicle 2. The monitor 9 shows maps and other information for car navigation. Also, when the vehicle 2 is reversing, the monitor 9 shows an outside image rearward and downward of the vehicle 2 captured by the camera C.

As shown in FIGS. 2A and 2B, the camera C of the present embodiment, which is a vehicle mounted camera, has a camera body 10 and a camera washer nozzle (camera nozzle) 11 integrally attached to the camera body 10. The camera nozzle 11 discharges washer fluid W to remove foreign matter such as rain drops and mud on an image capturing surface 10a of the camera body 10.

Specifically, the camera body 10 includes a substantially cubic housing H, an image sensor 10c located in the housing H, and a lens 10d. One side of the housing H forms the image capturing surface 10a, which has a circular image capturing window 10b. The image sensor 10c faces the image capturing window 10b via the lens 10d. The camera nozzle 11 has a holder 12 that detachably holds the camera body 10. The holder 12 substantially encompasses the camera body 10, while exposing the image capturing surface 10a.

A nozzle body 13 is located above the camera body 10. A substantially cylindrical connector 14 projects from the back side of the nozzle body 13 (a surface facing forward of the vehicle 2 when attached to the vehicle 2). The connector 14 is inserted into an end of a hose 7c, which diverges via a T-joint from the hose 7b extending toward the rear nozzle 6. This allows the washer fluid W to be supplied into the camera nozzle 11. A passage 15 for the washer fluid W is formed inside the connector 14. The passage 15 linearly extends in the nozzle body 13 from the back side toward the front side of the nozzle body 13 (from the front side toward the rear side in the vehicle 2). Further, the passage 15 reaches a discharge portion 16 (an inside spray hole 18 discussed below) located at the front side of the nozzle body 13 (the rear surface in the vehicle 2).

A check valve 17 is located in the passage 15. When the pump device 4 is activated to supply the washer fluid W, the check valve 17 opens to communicate with the discharge portion 16, thereby supplying the washer fluid W. When the pump device 4 is stopped, the check valve 17 closes and disconnects from the discharge portion 16, thereby stopping supply of the washer fluid W to the discharge portion 16. That is, when the pump device 4 is not operating, leakage of washer fluid W from the discharge portion 16 is prevented.

At the end of the passage 15, that is, at the boundary between the passage 15 and the discharge portion 16, the circular inside spray hole 18 is provided to be coaxial with the passage 15. The inside spray hole 18 has an open diameter that is sufficiently smaller than the inner diameter of the passage 15. The inside spray hole 18 sprays the washer fluid W having an increased flow velocity to the discharge portion 16 in a diffusing manner.

The discharge portion 16 is located above the camera body 10 (the image capturing window 10b) when viewed from the front of the camera body 10, and slightly projects relative to the image capturing surface 10a of the camera body 10. A discharge port 19 is located at the lower side (the surface at the vertically lower side) of the discharge portion 16. The discharge port 19 has a rectangular shape with the widthwise measurement greater than the front-rear measurement. One of the long sides is formed to be flush with the image capturing surface 10a. The opening length L1 of the discharge port 19 along the widthwise direction is substantially equal to the diameter L2 of the circular image capturing window 10b of the image capturing surface 10a. The opening length L3 of the discharge port 19 along the front-rear direction, which is perpendicular to the widthwise direction, is sufficiently less than the opening length L1 along the widthwise direction. Also, the discharge port 19 is formed to be flush with the image capturing surface 10a. Therefore, the projection amount of the discharge portion 16 relative to the image capturing surface 10a is sufficiently small.

A passage 20 formed in the discharge portion 16 connects the discharge port 19 with the inside spray hole 18. The passage 20 is a rectangular parallelepiped space having the same rectangular cross section as the opening shape of the discharge port 19. The passage 20 is formed along a plane perpendicular to the extending direction of the passage 15 in the nozzle body 13, which extends from the connector 14 to the inside spray hole 18. That is, the inner surface of the passage 20 includes a flat opposing surface 20a that faces the inside spray hole 18 and is perpendicular to the spray direction at the center of the inside spray hole 18. The passage 20 is parallel with the image capturing surface 10a. That is, the inner surface of the passage 20 includes a flat surface 20b that faces the opposing surface 20a. The flat surface 20b is flush with the image capturing surface 10a. In other words, the discharge port 19 (more specifically, the flat surface 20b, which defines a part of the discharge port 19) is formed adjacent to the image capturing surface 10a without a step in between. The passage 20 extends to a position vertically above the part in which the inside spray hole 18 is formed. That is, the passage 20 slightly extends in the direction opposite to the discharge port 19.

The camera nozzle 11 having the above described configuration is attached to the rear of the vehicle 2 together with the camera body 10. One end of the hose 7c is fitted to the connector 14 of the camera nozzle 11. When the pump device 4 is activated, the washer fluid W is supplied to the camera nozzle 11 as well as to the rear nozzle 6. In response to the supply of the washer fluid W, the check valve 17 in the nozzle body 13 is opened, so that the washer fluid W is supplied to the discharge portion 16 via the inside spray hole 18.

The washer fluid W sprayed from the inside spray hole 18 hits the opposing surface 20a in the discharge portion 16 and is then discharged from the discharge port 19 while filling the passage 20 in the discharge portion 16 and being regulated by the opening shape of the discharge port 19. That is, the washer fluid W passes through the passage 20, which extends along a direction intersecting the spray direction from the inside spray hole 18, and is then discharged through the discharge port 19 of the passage 20. More specifically, the washer fluid W is discharged at a high flow velocity parallel to the image capturing surface 10a of the camera body 10 and in a constant width covering at least the image capturing window 10b, so as to reliably wash away foreign object such as rain drops and mud from the image capturing surface 10a in an area around the image capturing window 10b.

The present embodiment has the following advantages.

(1) The camera nozzle 11 includes the inside spray hole 18 and the discharge portion 16, which has the passage 20 and the discharge port 19. The passage 20 extends along a direction perpendicular to the spray direction of the inside spray hole 18. The washer fluid W sprayed from the inside spray hole 18 is discharged from the discharge port 19 along the image capturing surface 10a of the camera body 10, while filling the passage 20. This washes the image capturing surface 10a. That is, since the washer fluid W is discharged along the image capturing surface 10a, the amount of projection of the discharge portion 16 relative to the image capturing surface 10a can be minimized. Since the washer fluid W is sprayed from the inside spray hole 18, its flow velocity is increased. Also, since the washer fluid W passes through the passage 20, the washer fluid W is discharged in a form suitable for washing the image capturing surface 10a (the image capturing window 10b, or a target to be washed). Therefore, the image capturing surface 10a is reliably washed.

(2) Since the discharge port 19 is formed to have no step with the image capturing surface 10a of the camera body 10, the washer fluid W discharged from the discharge port 19 can be supplied to the image capturing surface 10a while maintaining its high flow velocity. This ensures reliable washing while reducing the flow amount of the washer fluid W.

(3) The discharge port 19 discharges the washer fluid W along a direction parallel to the image capturing surface 10a of the camera body 10. This also ensures the supply of the washer fluid W to the image capturing window 10b, which is a target to be washed, while maintaining a high flow velocity. Also, this ensures reliable washing while reducing the flow amount of the washer fluid W.

(4) The discharge port 19 discharges the washer fluid W in a width that is substantially equal to the image capturing window 10b, which is a target to be washed in the image capturing surface 10a of the camera body 10. This ensures reliable washing while reducing the wasteful use of the washer fluid W.

(5) The discharge port 19 discharges the washer fluid W in the vertically downward direction. Therefore, even if the discharge pressure is low, the washer fluid W is supplied to the image capturing window 10b, which is a target to be washed, while maintaining a high flow velocity.

(6) The check valve 17 located in the passage 15 is opened when receiving the introducing pressure via the washer fluid W generated by operation of the pump device 4. This allows the washer fluid W to be discharged from the nozzle 11 only when in use. Therefore, leakage of the washer fluid W from the nozzle 11 (the discharge port 19) is prevented when not in use. This prevents the washer fluid W from collecting on the image capturing surface 10a of the camera body 10.

(7) The nozzle 11 detachably holds the camera body 10. Therefore, the existing camera body 10 can be attached to the nozzle 11. Only the camera 10 or only the nozzle 11 can be replaced, which facilitates maintenance.

(8) Since the nozzle 11 is integrated with the camera body 10, the nozzle 11 can be easily installed in the vehicle 2.

(9) Being attached to the rear of the vehicle 2, the rear view camera C is likely to be splashed with mud or water droplets when the vehicle 2 is moving. It is therefore advantageous to provide the rear view camera C with the nozzle 11. The vehicle 2 of the present embodiment has the rear nozzle 6 for spraying the washer fluid W onto the rear window 2b. Thus, it is easy to route the hose 7c for supplying the washer fluid W to the nozzle 11.

(10) A washer device 1 for a vehicle is configured to supply the washer fluid W, which is used for washing vehicle windows such as the windshield 2a and the rear window 2b of the vehicle 2, to the nozzle 11 for the camera body 10. Therefore, a means for supplying the washer fluid W to wash the image capturing surface 10a of the camera body 10 can be realized by a simple system.

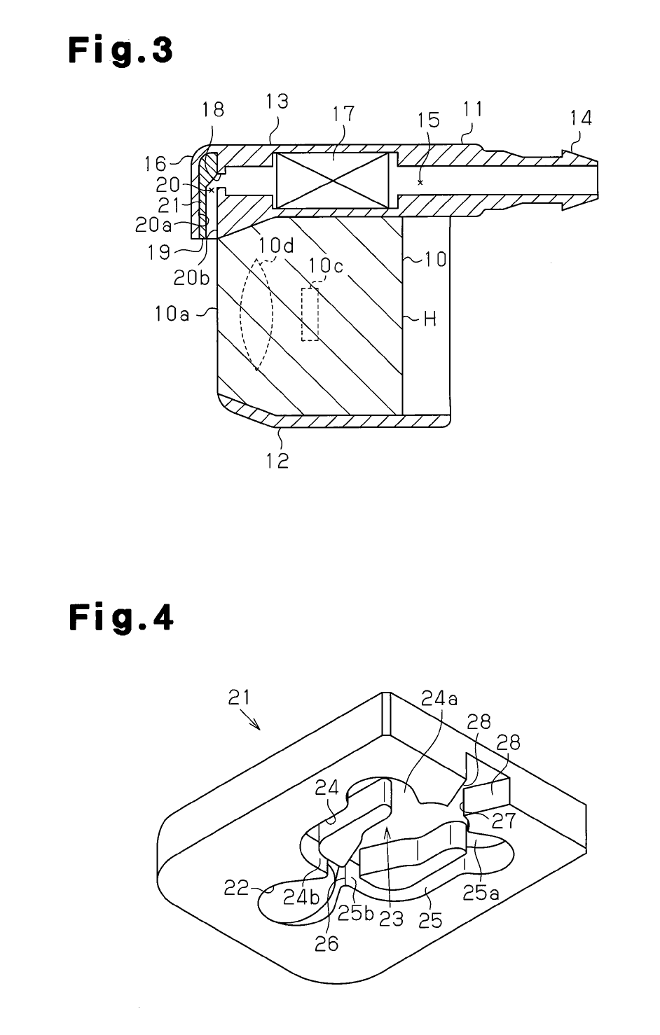

A second embodiment of the present invention will now be described with reference to FIGS. 3 to 5. The second embodiment is different from the first embodiment in that a fluidic device for diffusing and spraying washer fluid W is installed in the passage 20 of the discharge portion 16. Like or the same reference numerals are given to those components that are like or the same as the corresponding components of the first embodiment.

As shown in FIGS. 3 and 4, a fluidic device 21 is substantially shaped like a plate and has a passage 22. When the fluidic device 21 is installed in the passage 20, the passage 22 communicates with the inside spray hole 18. The fluidic device 21 also includes a control chamber 23 communicating with the passage 22 and a pair of feedback passages 24, 25.

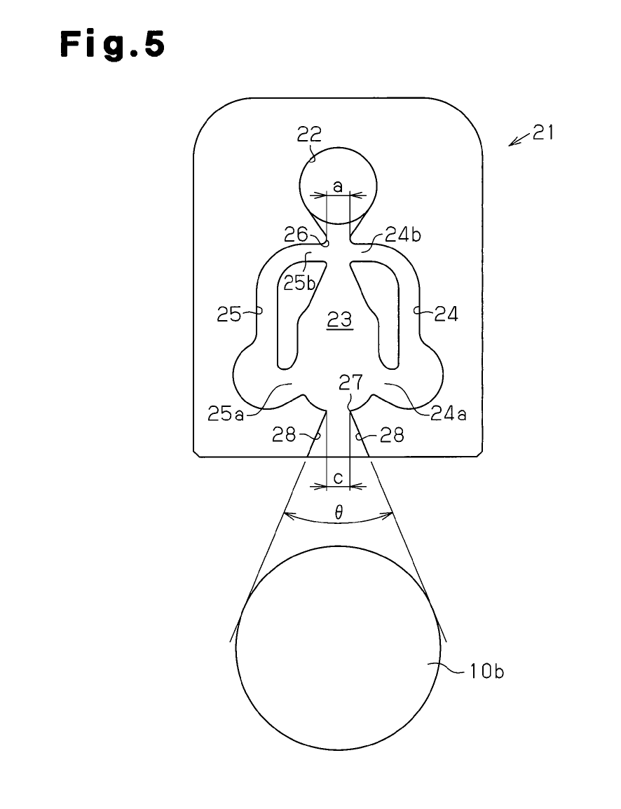

As illustrated in detail in FIG. 5, an inflow port 26 is formed at the inlet of the control chamber 23. The inflow port 26 guides the washer fluid W sprayed into the passage 22 from the inside spray hole 18 to the control chamber 23. The washer fluid W is supplied to the control chamber 23 via the inflow port 26.

A diffusion spray port 27 is provided at the outlet of the control chamber 23. The diffusion spray port 27 is located on the same axis as the inflow port 26. A pair of spray side walls 28, which face each other, is provided downstream of the diffusion spray port 27. The spray side walls 28 extend such that the distance therebetween gradually increases along the spray direction of the washer fluid W from the diffusion spray port 27. The spray side walls 28 define a predetermined angle θ. Accordingly, the washer fluid W is sprayed while being diffused by the predetermined angle θ from the diffusion spray port 27. The predetermined angle θ is determined based on the area ratio of the cross-sectional area of the inflow port 26 (proportional to a) to the cross-sectional area of the diffusion spray port 27 (proportional to c). In the present embodiment, the predetermined angle θ is set to such value that the washer fluid W sprayed from the diffusion spray port 27 covers at least the image capturing window 10b of the camera body 10. For example, the predetermined angle θ is substantially equal to the angle defined by two lines that extend from the diffusion spray port 27 and are tangent to the circumference of the image capturing window 10b.

The feedback passages 24, 25 diverge from the control chamber 23 on both sides in the lateral direction. The feedback passages 24, 25 have inlets 24a, 25a connected to the control chamber 23 in the vicinity of the diffusion spray port 27 and outlets 24b, 25b connected to the control chamber 23 in the vicinity of the inflow port 26. Therefore, the feedback passages 24, 25 separately guide some of the washer fluid W, which has been supplied to the control chamber 23 from the passage 22, from the inlets 24a, 25a, thereby returning the washer fluid W to the outlets 24b, 25b. The washer fluid W guided by the feedback passages 24, 25 form “control flows” that cause self oscillation of the washer fluid W flowing through the control chamber 23. The fluidic device 21 as described above is disclosed, for example, in Japanese Laid-Open Patent Publication No. 2006-001529.

The present embodiment has the same advantages as the advantages (1) to (3) and (5) to (10) of the first embodiment.

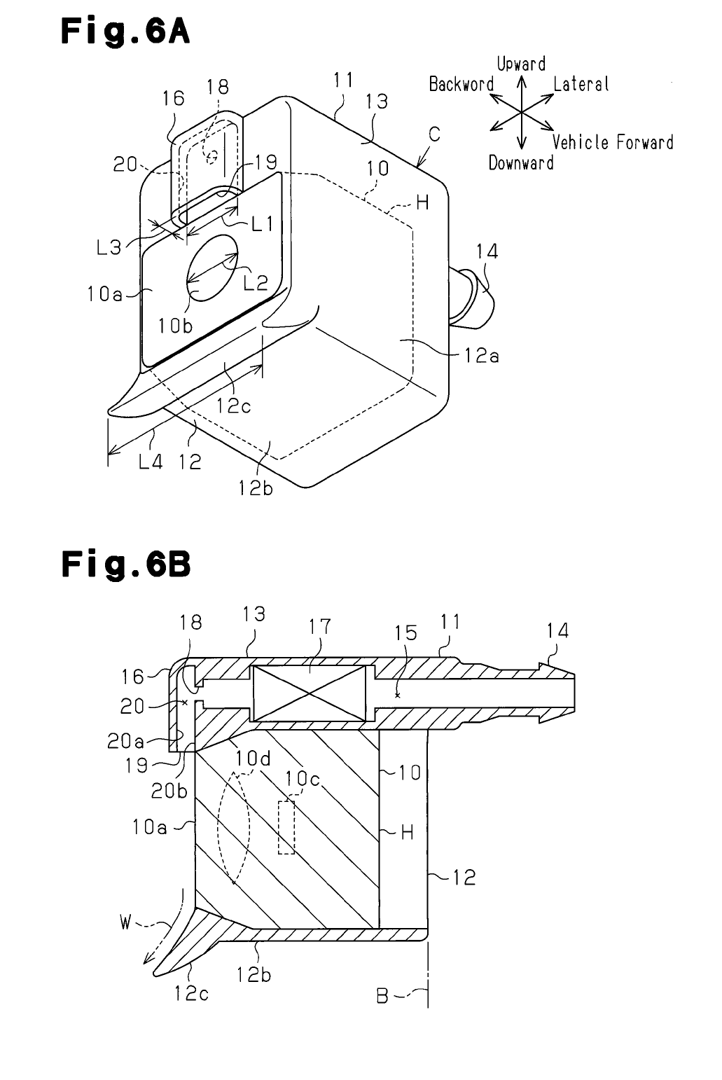

A third embodiment of the present invention will now be described with reference to FIGS. 6A and 6B. Like or the same reference numerals are given to those components that are like or the same as the corresponding components of the first embodiment.

The holder 12 of the camera nozzle 11 has a pair of side walls 12a and a bottom 12b. The side walls 12a extend from the nozzle body 13 to cover the sides of the camera body 10 in the widthwise direction, and the bottom 12b covers the bottom of the camera body 10.

A sloped crease 12c is formed at the end of the bottom 12b corresponding to the rear of the vehicle 2. As shown in FIG. 6B, the crease 12c extends obliquely such that it is spaced further away from the vehicle body B toward the lower end from the bottom 12b. The distal end of the crease 12c is located further rearward in the vehicle 2 relative to the image capturing surface 10a of the camera body 10 and the discharge port 19 of the nozzle body 13. Also, as shown in FIG. 6A, the crease 12c is formed over the entire width of the bottom 12b. The width L4 of the crease 12c is larger than the diameter L2 of the image capturing window 10b.

The washer fluid W discharged from the discharge port 19 washes the image capturing surface 10a and then flows vertically downward to reach the crease 12c. The washer fluid W is guided away from the vehicle body B along the sloped shape of the crease 12c, and drops off the crease 12c without contacting the vehicle body B. Accordingly, the washer fluid W discharged from the discharge port 19 is prevented from flowing around to the bottom 12b after washing the image capturing surface 10a and collecting on the vehicle body B.

According to the present embodiment, the following advantages are obtained in addition to the advantages (1) to (10) of the first embodiment.

(11) According to the present embodiment, the camera C includes the housing H, and the image capturing window 10b attached to the housing H, and the camera nozzle 11 supplies the washer fluid W to the image capturing window 10b (the lens 10d). The crease 12c is located at a position vertically below the image capturing window 10b to prevent the washer fluid W, which has flowed from vertically above, from flowing around to the bottom of the housing H. This prevents the washer fluid W supplied from the nozzle body 13 from flowing around to the bottom of the housing H and from collecting on the vehicle body B.

(12) In the present embodiment, since the crease 12c projects in a direction away from the vehicle body B, the washer fluid W supplied from the nozzle body 13 is guided by the crease 12c to be directed away from the vehicle body B after washing the image capturing window 10b. This reliably prevents the washer fluid W from collecting on the vehicle body B.

(13) In the present embodiment, the nozzle body 13 has the check valve 17, which is located upstream of the discharge port 19 for supplying the washer fluid W. Therefore, the washer fluid W remaining in the nozzle body 13 is prevented from leaking from the discharge port 19 when the vehicle 2 is accelerated, for example, when the vehicle 2 starts moving. If such leakage occurs, air can enter the passage 15 and lower the responsiveness of the supply of washer fluid W. The configuration of the present embodiment prevents such a drawback.

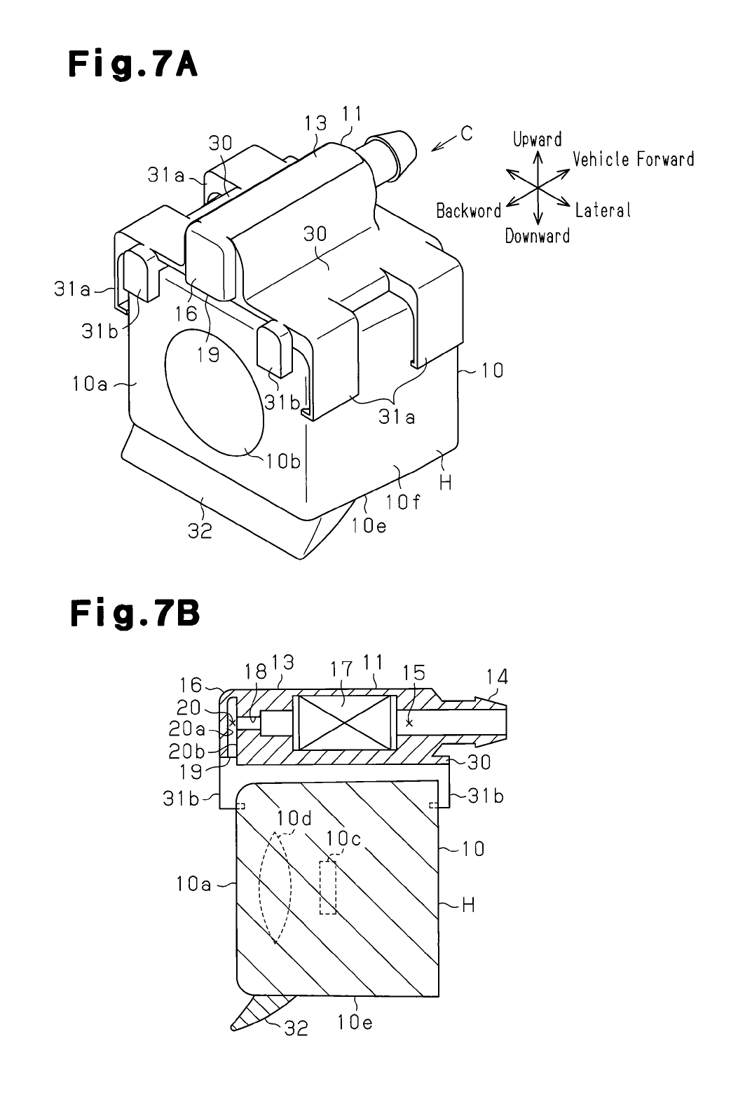

A fourth embodiment of the present invention will now be described with reference to FIGS. 7A and 7B.

The fourth embodiment is different from the third embodiment in that the structure for fixing the camera nozzle 11 and the camera body 10. Like or the same reference numerals are given to those components that are like or the same as the corresponding components of the third embodiment.

As shown in FIGS. 7A and 7B, the camera nozzle 11 of the present embodiment has a flange 30 extending in the widthwise direction from the lower end, four first engaging claws 31a, and four second engaging claws 31b. The engaging claws 31a, 31b are formed on the flange 30. Two of the first engaging claws 31a are formed on each widthwise end of the flange 30, and two second engaging claws 31b are formed on each of the front and rear ends of the flange 30. The first and second engaging claws 31a, 31b, which function as holders, have elasticity and are each engaged with the housing H of the camera body 10. Specifically, the first engaging claws 31a are engaged with side walls 10f of the housing H in the widthwise direction, and the second engaging claws 31b are engaged with the image capturing surface 10a and the side opposite to the image capturing surface 10a. The engagement of the first and second engaging claws 31a, 31b fixes the camera body 10 and the camera nozzle 11 to each other.

Also, a crease 32 having the same shape as that in the second embodiment is bonded to the bottom 10e of the housing H of the present embodiment. The crease 32 functions in the same manner as that in the third embodiment, so that the present embodiment has the same advantages as the third embodiment.

In addition, since the camera body 10 and the camera nozzle 11 are fixed to each other by the engagement of the first and second engaging claws 31a, 31b, the camera nozzle 11 can be easily attached to and detached from the camera body 10. Accordingly, a vehicle mounted camera without a camera nozzle can be retrofitted with the camera nozzle 11 to form a washer device for a vehicle. Compared to the case of the holder 12 of the first to third embodiments, which encompass the camera body 10 from the four directions, the vertical dimension can be reduced.

Also, in the present embodiment, the first engaging claws 31a are engaged with the side walls 10f of the housing H in the widthwise direction, and the second engaging claws 31b are engaged with the end faces of the housing H in the front-rear direction. Therefore, the relative positions of the nozzle body 13 and the camera body 10 can be determined with respect to the widthwise direction and the front-rear direction.

The embodiments of the present invention may be modified as follows.

In the above illustrated embodiments, the camera nozzle 11 detachably holds the camera body 10. However, the camera nozzle 11 may be formed integrally with the housing of the camera body 10.

In the above illustrated embodiments, the passage 20 in the discharge portion 16 extends along a direction perpendicular to the spray direction at the center of the inside spray hole 18. However, the passage 20 may extend to obliquely intersect the spray direction at an angle other than the right angle, so that the washer fluid W hits the opposing surface 20a of the passage 20 at an oblique angle.

In the above illustrated embodiments, the passage 20 in the discharge portion 16 is parallel to the image capturing surface 10a of the camera body 10. However, the passage 20 may extend obliquely relative to the image capturing surface 10a, so that the washer fluid W may be discharged obliquely relative to the image capturing surface 10a. Also, a small step may be formed between the discharge port 19 and the image capturing surface 10a. The washer fluid W is discharged vertically downward from the discharge port 19 in the above described embodiments. However, the discharge direction may be changed.

In the first, third, and fourth embodiments, the washer fluid W is discharged from the discharge port 19 at a width substantially equal to the diameter L2 of the image capturing window 10b. However, the washer fluid W may be discharged such that its width gradually increases. The washer fluid W from the discharge port 19 does not need to be discharged at a width substantially equal to the diameter L2 of the image capturing window 10b.

In the above illustrated embodiments, the check valve 17 is located in the camera nozzle 11. However, the check valve 17 may be omitted if the flow of fluid can be sufficiently reliably stopped.

In the above illustrated embodiments, the hose 7c diverges from the hose 7b, which is connected to the rear nozzle 6, and the hose 7c is connected to the camera nozzle 11, so that the washer fluid W is discharged from the camera nozzle 11 at the same time as the washer fluid W is sprayed from the rear nozzle 6. However, the rear nozzle 6 and the camera nozzle 11 may be configured to operate independently from each other. Specifically, pump devices 4 may be provided to correspond to each of the rear nozzle 6 and the camera nozzle 11. Alternatively, a diversion valve may be employed to switch between a passage to the rear nozzle 6 and a passage to the camera nozzle 11.

In the above illustrated embodiments, the camera nozzle 11 is applied to the rear view camera C for viewing the rear. However, the camera nozzle 11 may be applied to other types of vehicle mounted cameras such as a side view camera for viewing the side or a front view camera for viewing the front.

In the third embodiment, the crease 12c is integrally formed with the holder 12. However, the present invention is not limited to this structure. For example, the crease 12c may be bonded to the holder 12. Alternatively, the crease 12c may be detachably attached to the holder 12.

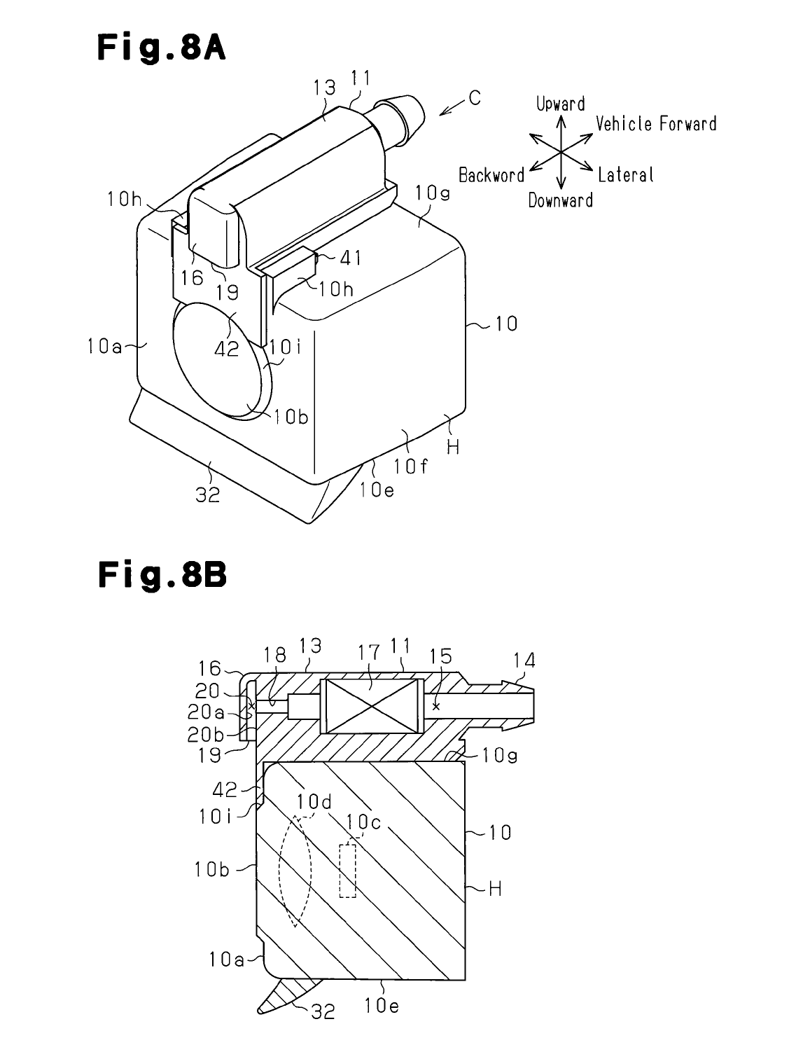

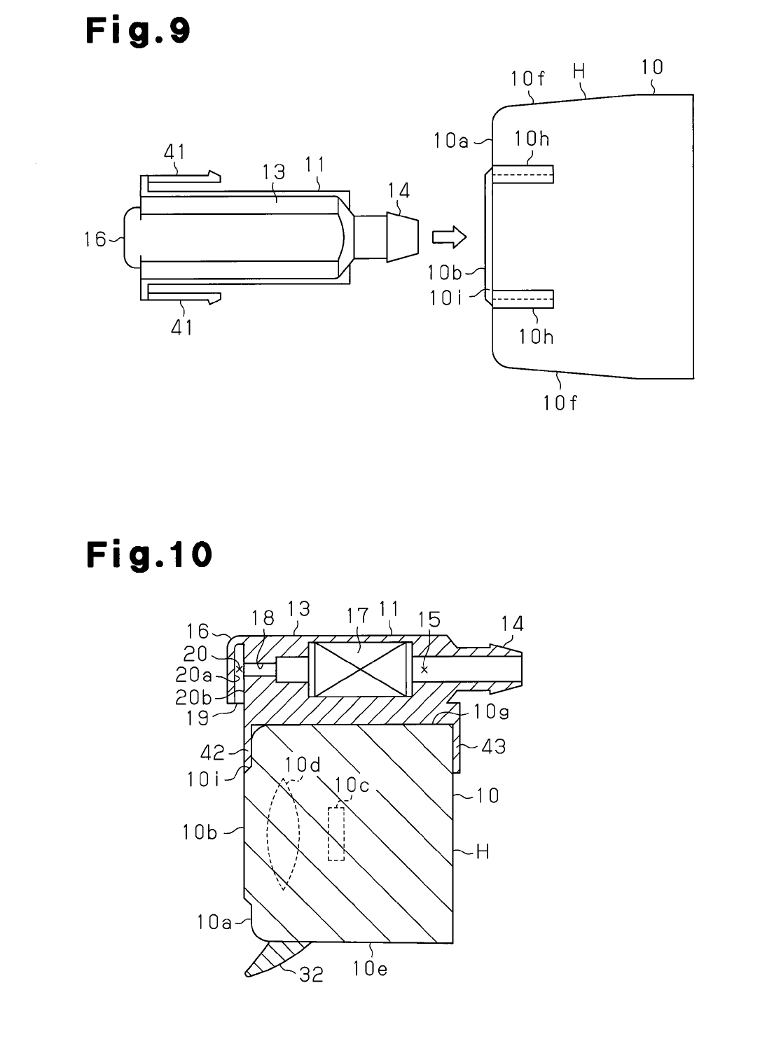

In the fourth embodiment, the camera body 10 and the camera nozzle 11 are fixed to each other by the engagement of the first and second engaging claws 31a, 31b. However, the present invention is not limited to this structure. For example, the structure illustrated in FIGS. 8A to 9 may be employed. According to the structure shown in FIGS. 8A to 9, a pair of elastic engaging hooks 41 is formed at the both sides of the nozzle body 13 in the widthwise direction. The elastic engaging hooks 41 extend forward from the end of the nozzle body 13 corresponding to the rear of the vehicle 2. The elastic engaging hooks 41, which function as holders, are engaged with a pair of upright engaging portions 10h formed on the upper surface 10g of the housing H, so that the camera body 10 and the nozzle body 13 are fixed to each other.

In the example shown in FIGS. 8A to 9, the image capturing window 10b of the camera body 10 slightly projects relative to the image capturing surface 10a. An inclined portion 10i is formed at the periphery of the image capturing window 10b. The inclined portion 10i is tapered such that its diameter decreases as the distance from the image capturing surface 10a increases. An extended portion 42 extends downward (toward the camera body 10) from the end of the nozzle body 13 corresponding to the rear of the vehicle 2. The lower end of the extended portion 42 contacts the upper part of the inclined portion 10i of the image capturing window 10b along the up-down direction. Accordingly, the position of the nozzle body 13 is determined with respect to the up-down direction.

Also, in the fourth embodiment and the example shown in FIGS. 8A to 9, the camera body 10 and the camera nozzle 11 are fixed to each other by the engagement of the first and second engaging claws 31a, 31b or the elastic engaging hooks 41. However, the camera body 10 and the camera nozzle 11 may be fixed to each other through adhesion.

In the example shown in FIGS. 8A to 9, the camera nozzle 11 and the camera body 10 are fixed to each other by the engagement of the elastic engaging hooks 41 and the upright engaging portions 10h. However, the present invention is not limited to this structure. For example, as shown in FIG. 10, an engaging claw 43 may project downward (toward the camera 10) from the end of the nozzle body 13 corresponding to the front of the vehicle 2. In this case, the extended portion 42 at the end of the nozzle body 13 corresponding to the rear of the vehicle 2 and the engaging claw 43 are engaged with the housing H of the camera body 10, so that the camera nozzle 11 and the camera body 10 are fixed to each other. The extended portion 42 and the engaging claw 43 function as holders.

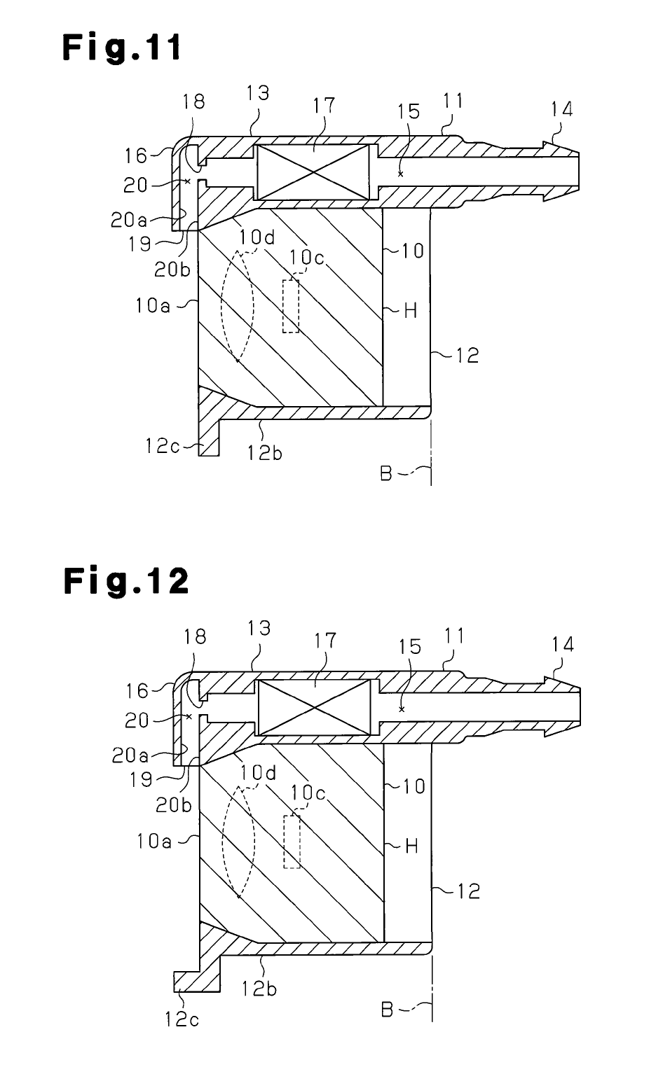

In the third and fourth embodiments, the creases 12c, 32 are sloped such that they spaced gradually away from the vehicle body B. However, the present invention is not limited to this structure. For example, as shown in FIG. 11, the crease 12c may extend downward to be parallel to the vehicle body B. Alternatively, as shown in FIG. 12, the crease 12c may be shaped as an L by extending the crease 12c downward to be parallel to the vehicle body B and then rearward in the vehicle. In these structures, the same advantages as the third and fourth embodiments are achieved.

In the third and fourth embodiments, the creases 12c, 32 are provided over the entire width of the holder 12 or the housing H. However, the present invention is not limited to this structure. That is, the measurement of the crease 12c, 32 along the width may be less than the measurement of the holder 12 or the housing H.

In the third and fourth embodiments, the crease 12c, 32 is provided on the bottom 12b of the holder 12 or on the bottom 10e of the housing H of the camera body 10. However, as long as the crease 12c, 32 is provided at a position vertically downward of the image capturing window 10b, the crease 12c, 32 may be provided at any position. For example, the crease 12c, 32 may be provided on the image capturing surface 10a.

1. A washer nozzle for removing foreign matter on an image capturing surface of a camera mounted to the outside of a vehicle by supplying washer fluid to the image capturing surface, the washer nozzle comprising:
an inside spray hole for spraying washer fluid introduced into the washer nozzle; and
a discharge portion for receiving washer fluid sprayed from the inside spray hole, the discharge portion having a passage extending in a direction intersecting the spray direction of the washer fluid and a discharge port connected to the passage,
wherein the discharge portion discharges, from the discharge port, washer fluid sprayed from the inside spray hole along the image capturing surface, while filling the passage with the washer fluid, thereby washing the image capturing surface.

2. The washer nozzle according to claim 1, wherein the discharge port is provided so as not to form a step with the image capturing surface of the camera.

3. The washer nozzle according to claim 2, wherein the discharge portion is configured to discharge, from the discharge port, washer fluid in a direction parallel to the image capturing surface.

4. The washer nozzle according to claim 1, wherein the discharge portion is configured to discharge, from the discharge port, washer fluid in a width that is substantially equal to a target to be washed on the image capturing surface.

5. The washer nozzle according to claim 1, wherein the discharge portion is configured to discharge, from the discharge port, washer fluid in a vertically downward direction.

6. The washer nozzle according to claim 1, further comprising a check valve that is opened when receiving an introducing pressure via washer fluid.

7. The washer nozzle according to claim 1, further comprising a holder that detachably holds the camera.

8. The washer nozzle according to claim 1, further comprising a fluidic device is installed in the passage, wherein the fluidic device has an inflow port through which washer fluid sprayed from the inside spray hole flows in, a control chamber connected to the inflow port, and a diffusion spray port connected to the control chamber, and wherein the control chamber is configured to spray washer fluid flowing into the control chamber from the inflow port from the diffusion spray port as a diffused flow having a predetermined diffusion angle.

9. The washer nozzle according to claim 8, wherein the diffusion angle is set to such a value that the washer fluid sprayed from the diffusion spray port covers at least a target to be washed on the image capturing surface.

10. The washer nozzle according to claim 8, wherein the diffusion angle is substantially equal to the angle defined by two lines that extend from the diffusion spray port and are tangent to the outer shape of a target to be washed on the image capturing window surface.

11. A vehicle mounted camera integrally having the washer nozzle according to claim 1.

12. The vehicle mounted camera according to claim 11, wherein the camera is a rear view camera attached to the rear of a vehicle.

13. A washer device for a vehicle that washes a window of a vehicle using washer fluid, wherein washer fluid is introduced into the washer nozzle according to claim 1, and the washer fluid is also discharged from the discharge port to the image capturing surface of the camera.

14. A camera mounted to the outside of a vehicle, comprising a housing, a camera body having an image capturing surface provided on the housing, and a washer nozzle for supplying washer fluid onto the image capturing surface, wherein the camera further comprises a crease located at a part vertically below the image capturing surface, the crease preventing washer fluid that has flowed from vertically above from flowing around to the bottom of the housing.

15. The camera according to claim 14, wherein the crease projects in a direction away from the body of the vehicle.

16. The camera according to claim 14, wherein the washer nozzle further includes a check valve that is located upstream of the discharge port for supplying washer fluid.

17. A vehicle mounted washer device comprising:
a camera body having a housing and an image capturing surface provided on the housing; and
a washer nozzle for supplying washer fluid onto the image capturing surface, wherein
the camera body and the washer nozzle are mounted to the outside of the vehicle, and
the washer device further comprises a crease located at a part vertically below the image capturing surface, the crease preventing washer fluid that has flowed from vertically above from flowing around to the bottom of the housing.
